(19) United States
(12) Patent Application Publication
(10) Pub. No.: US 2024/0386389 A1
(43) Pub. Date: Nov. 21, 2024

(54) METHOD FOR OPERATING A MOBILE, SELF-PROPELLED APPLIANCE

(71) Applicant: BSH Hausgeräte GmbH, München (DE)

(72) Inventors: Kristina Daniel, Bad Neustadt (DE); Frank Schnitzer, Bad Neustadt (DE); Kai Schmitt, Saal (DE)

(21) Appl. No.: 18/693,553

(22) PCT Filed: Sep. 5, 2022
(86) PCT No.: PCT/EP2022/074573

§ 371 Date: Mar. 20, 2024

(30) Foreign Application Priority Data
Sep. 24, 2021 (DE) 10 2021 210 678.1

(51) Int. Cl. G06Q 10/1093; A47L 9/28; A47L 11/24; A47L 11/28; A47L 11/40

(52) U.S. Cl. CPC G06Q 10/1097; A47L 9/2836; A47L 11/24; A47L 11/28; A47L 11/4011; A47L 2201/04; A47L 2201/06

(57) ABSTRACT

A method operates a mobile, self-propelled appliance, in particular a floor-cleaning appliance such as a robot vacuum cleaner and/or robot sweeper and/or robot mop. In which method a user predefines, on a portable accessory, which cleaning tasks are to be performed in a predefined time window and determines a number of performances in this predefined time window and also further cleaning parameters and/or boundary conditions. The mobile, self-propelled appliance automatically generates a task allocation as to when which cleaning tasks are performed in the predefined time window with the provided cleaning parameters and/or boundary conditions.

The present invention relates to a method for operating a mobile, self-propelled appliance, in particular a floor-cleaning appliance such as a vacuuming and/or sweeping and/or mopping robot for the autonomous processing of floor surfaces.

Mobile, self-propelled appliances such as for example robot vacuum cleaners have the task of autonomously cleaning, where possible, an entire floor. In this case, these appliances are to execute their cleaning tasks as independently as possible, preferably without an explicit command from a user. Known cleaning robots offer for this purpose, inter alia, cleaning schedules in which the user can define at which time which room is to be cleaned. These schedules provide the cleaning robot with precise instructions regarding at which time the cleaning job is to start.

If over the week multiple rooms are to be cleaned or one room is to be cleaned multiple times, the user must retain the overview themselves as to when which cleaning job is to start. For users who have demanding ideas in terms of the cleaning frequency of various rooms, this can under certain circumstances lead to a complex listing which the user themselves has to manage.

If during the cleaning jobs an unforeseen event occurs, for example, in which the user stops the cleaning robot working in order not to be disturbed or in which a door is closed as a result of which the cleaning robot cannot clean a room that is to be cleaned, the cleaning job is possibly not performed or is at least not completely executed. There is no provision for renewed cleaning. This can be unsatisfactory for the user.

The object of the invention is to provide a method for operating a mobile, self-propelled appliance, in particular a floor cleaning appliance, which avoids the above mentioned disadvantages and in particular ensures an automatic and/or flexible task scheduling by the mobile, self-propelled appliance.

This object is achieved by a method for operating a mobile, self-propelled appliance having the features of claim 1. Advantageous embodiments and developments are the subject of the subordinate claims.

According to the invention, in the case of a method for operating a mobile, self-propelled appliance, in particular a floor cleaning appliance, such as a robot vacuum cleaner and/or a sweeping robot and/or a mopping robot, a user specifies on a portable additional device which at least one cleaning task, in particular floor cleaning, is to be executed in at least one predetermined time window. In addition, the user specifies a number of executions in this predetermined time window and further cleaning parameters and/or boundary conditions, wherein the mobile, self-propelled appliance generates, in a self-acting manner, a task allocation and/or task schedule as to when which cleaning tasks are to be performed in the predetermined time window using the specified cleaning parameters and/or boundary conditions.

Thus, a method is primarily described in which an automatic and/or flexible allocation of tasks or scheduling of tasks is performed by the mobile, self-propelled appliance, wherein the user merely specifies, for example, which rooms they would like cleaned how often, and in which time window the appliance itself can freely schedule these tasks. It is preferred that the appliance preferably independently adapts the task schedule and postpones jobs in the event that these could not take place. The user therefore prefers to leave the task allocation to the appliance for processing the cleaning tasks. Cleaning tasks that were scheduled but partially executed or completely prevented are rescheduled by the appliance itself so that the cleaning does not have to be cancelled.

According to the invention, the user does not fixedly define on which days and at which time which cleaning program is to be executed. Instead, the user specifies 27 which areas of the home are to be cleaned and how often per day, per week or per month. The mobile, self-propelled appliance is provided with time windows, i.e. permitted days and/or permitted time ranges, in which the appliance can freely schedule when it executes which cleaning task. Such time windows can be, for example, when the user knows that they are not at home, the children are at nursery and/or the user is at work. This type of task allocation is easier for the user to manage, as they do not have to worry in detail about which tasks are to be executed on which days and at which times.

The advantage for the user is less scheduling effort for time-controlled tasks, since the mobile, self-propelled appliance takes over the allocation and scheduling of the specified tasks itself. This provides the user with a clear listing of the scheduled tasks and their frequency. In addition, the user can also be sure that the tasks they have defined will be executed, even if unforeseen events intervene. Tasks are automatically postponed if they could not be completed in the previously scheduled time window. This advantageously results in an adaptive and flexible allocation of tasks. Despite unforeseen events, the desired cleaning tasks are executed reliably. The user's personal preferences are still taken into account.

A mobile, self-propelled appliance is in particular a floor cleaning appliance, for example a cleaning or lawn mowing appliance, which autonomously processes floor surfaces or lawns, in particular in the household sector. This includes, inter alia, vacuuming and/or sweeping and/or mopping robots such as robot vacuum cleaners or robot lawn mowers. These appliances preferably work during the operation (cleaning mode or lawn mowing mode) with as little as possible or no user intervention. For example, the appliance moves in a self-acting manner into a predetermined room in order to clean the floor according to a predetermined and programmed process strategy.

In order in so doing to be able to take into account any individual surrounding features, an exploration run is preferably carried out using the mobile, self-propelled cleaning appliance. In particular, an exploration run is an exploratory run that is suitable for investigating a floor area to be processed for obstacles, spatial distribution and the like. The aim of an exploration run is in particular to be able to assess and/or visualize the conditions of the floor processing area to be processed.

After the exploration run, the mobile, self-propelled appliance knows its surroundings and can pass them on to the user in the form of a map of the surroundings, for example in an app on a mobile device. The map of the surroundings can be used to provide the user with the opportunity to interact with the mobile, self-propelled appliance. The user can advantageously view information in the map of the surroundings and change and/or adapt it if necessary.

A map of the surroundings is to be understood in particular as any map that is suitable for depicting the surroundings of the floor processing area with all its obstacles and objects. For example, the map of the surroundings shows the floor processing area with the furniture and walls contained therein in the form of an outline.

The map of the surroundings with the obstacles is preferably displayed in the app on a portable additional device. This is used in particular to visualize a possible interaction for the user.

In the present case, an additional device is to be understood in particular as any device that is portable for a user, that is arranged outside the mobile, self-propelled appliance, in particular is external and/or differentiated from the mobile, self-propelled appliance, and is suitable for displaying, providing, transmitting and/or transferring data, such as a cell phone, a smartphone, a tablet and/or a computer or laptop.

In particular, the app, especially a cleaning app, is installed on the portable additional device and is used for communication between the mobile, self-propelled appliance and the additional device and, in particular, enables visualization of the floor processing area, i.e. the living space to be cleaned or the home to be cleaned or the living area. The app preferably shows the user the area to be cleaned as a map of the surroundings as well as any obstacles.

A predetermined time window means, for example, permitted days of the week and/or permitted time ranges per day, per week and/or per month, which do not have to be directly adjacent to each other. Such time windows are useful, for example, if the user knows that they are not at home because they are at work. A predetermined time window (per week) can be as follows, for example: Monday to Thursday from 8 a m to 4 p m, Friday from 8 a m to 12 p m and Saturday from 12 p m to 4 p m.

In particular, the number of executions refers to the frequency of identical or at least similar cleaning tasks to be performed in the predetermined time window. For example, the following can be specified by the user as the number of executions: three times in the predetermined time window (for example per week). In the time window specified above, the kitchen is vacuumed three times per week, for example, Monday at 10 am, Wednesday at 11 am and Friday at 11 a m, for example.

Other cleaning parameters include, for example, the cleaning mode, the cleaning performance, the maximum volume, the amount of water in the case of mopping robots and the like.

Boundary conditions include, in particular, any conditions that are not yet covered by the time window. For example, in the time window, a period of time is defined in which the mobile, self-propelled appliance is to vacuum, but only in rooms or with appliance settings in which/with which the user is not disturbed in the said time window, for example.

In a self-acting manner means, in particular, independently, automatically and/or without user intervention. The mobile, self-propelled appliance can therefore freely schedule when it carries out which cleaning task within the predetermined time window. The user does not have to worry in detail about which tasks are to be executed on which days and at which times. There is therefore no fixed definition of which cleaning program is to be executed on which days and at which time. Instead, the user specifies, for example, which areas of the home are to be cleaned how often per week or per month. The mobile, self-propelled appliance then carries out the exact scheduling itself taking into account the user's specifications.

Task allocation refers in particular to the detailed scheduling of the cleaning schedule. In particular, the allocation of tasks involves specifying exact times and/or a duration for carrying out certain cleaning activities.

The floor area to be processed is any room area to be cleaned. This also includes inter alia sub-areas of individual rooms, individual areas of a home, individual rooms of a home and/or the entire floor area of the entire home or living space.

In an advantageous embodiment, the mobile, self-propelled appliance automatically allocates tasks. In particular, the appliance is provided with time windows in which it can freely schedule when it takes on which task. This advantageously allows the appliance to optimize the allocation of tasks.

In a further advantageous embodiment, the mobile, self-propelled appliance reschedules a cleaning task that was scheduled by the user but was partially executed or prevented. In the event that a cleaning task cannot be executed as scheduled, this task is subsequently postponed to another time window and automatically rescheduled, i.e. without user intervention. This advantageously means that the user does not have to take any action and, in particular, does not have to worry about whether an action carried out by the user overlaps with a scheduled task of the appliance. In particular, the appliance ensures, in a self-acting manner or independently, that all desired tasks are executed.

If, for example, the execution of the cleaning job on a Monday morning is prevented because the user has started a spontaneous cleaning job or because the user has pressed a “do not clean today” button, the missed cleaning job is rescheduled on Monday afternoon or Tuesday, for example.

In a further advantageous embodiment, the other cleaning parameters and/or boundary conditions are the cleaning mode, the cleaning performance, the maximum volume and/or the amount of water.

In a further advantageous embodiment, a common time window and/or at least partially different time windows are predetermined for the cleaning tasks to be executed. In particular, the user specifies on the portable additional device in the associated cleaning app which time windows he wants to allow for which cleaning program. In addition to specifying times of day, such as the start and end of the time window, the user can also assign days of the week to the time windows and thus map different boundary conditions for different days. The mobile, self-propelled appliance assigns the specified cleaning tasks to the permitted time windows.

In a further advantageous embodiment, the task allocation is created by means of a scheduling algorithm and/or an optimization algorithm. In particular, at least after each change to the user's input, preferably at regular intervals, the scheduling and optimization algorithm schedules the tasks defined by the user into the predetermined time windows. For example, the cleaning tasks for the same rooms can be evenly allocated over a week. If, for example, the cleaning of a room is scheduled three times per week and limited to working days, the tasks are scheduled for Monday, Wednesday and Friday, provided that permitted time windows and other cleaning tasks allow this.

In a further advantageous embodiment, the scheduling algorithm and/or optimization algorithm uses stored log data from previous cleaning jobs. In this way, the required duration of the respective cleaning task, required and/or used battery charge per room for predetermined cleaning parameters and/or necessary times for recharging the battery can be used in the optimization of the cleaning schedule. In this way, the mobile, self-propelled appliance can allocate the cleaning tasks into different time windows of a weekday in advance in order to take battery recharging into account. An optimized allocation of tasks with optimum battery charging is an advantage.

If required, the result of the current task allocation can be displayed to the user in the cleaning app on the portable additional device, for example in the form of a list or a matrix table with days of the week and time windows like a timetable.

In a further advantageous embodiment, the scheduling algorithm and/or optimization algorithm allocates cleaning jobs that have similar or identical goals, in particular, as evenly as possible over the time window. In this way, duplication of tasks in particular can be avoided. In particular when scheduling or postponing tasks, the scheduling algorithm and/or optimization algorithm checks whether there are cleaning jobs that have a similar or identical goal in the corresponding time windows or on the corresponding day. For example, cleaning which the user specifies seven times per week does not necessarily have to take place twice on the same day.

In a further advantageous embodiment, the user is shown unavailable time windows and/or feedback regarding an improved task allocation on the portable additional device. During the scheduling phase for task allocation, the scheduling algorithm therefore not only checks which cleaning tasks can take place in which time windows, but also whether the intended cleaning tasks can be fitted into the predetermined time windows. If it is determined, for example, that a cleaning task is limited to specific days, but no time window or only an insufficiently long time window is available for these days, the user is informed immediately. If no change is made by the user, the tasks can be omitted depending on the execution or can be scheduled on days with given time windows with an additional notification to the user. Information about unavailable time windows can be displayed to the user directly in the cleaning app on the portable additional device.

The user can also be given feedback on whether the available time windows are sufficient for the defined cleaning tasks, for example, or whether time windows need to be postponed in order to provide sufficient time for recharging the battery. In this case, the appliance prefers to use data learned from previous cleaning runs. The scheduling algorithm can also show the user suggestions on how to adapt the time windows to better suit the predetermined cleaning tasks.

The instructions to the user can be displayed in different variants in the cleaning app. For example, warning notifications are suitable for this if the combination of predetermined cleaning tasks and time windows does not allow a solution for scheduling, and/or information notifications if the given time windows do not allow an optimal solution, but the tasks can still be scheduled with the given boundary conditions.

In addition, the task allocation can be linked to a button in the cleaning app, which the user can use to inform the mobile, self-propelled appliance that they do not want to be disturbed on the current day or in the next few hours. A “not today” button is suitable for this purpose, for example, which prevents the scheduled tasks from being executed when pressed. The appliance will then attempt, in a self-acting manner, to postpone and reschedule the cancelled tasks so that all cleaning tasks are executed reliably. In addition, if the “not today” button is pressed repeatedly within the same time window, the cleaning app can suggest that this time window be cancelled completely or at least partially in the future. This allows the entire system to adapt preferably independently to changes in user preferences. These time windows can be cancelled automatically, for example, where appropriate with an additional notification to the user. Alternatively, a semi-automatic deletion is provided, in which a request to the user and a manual confirmation for deletion by the user is implemented.

In addition or alternatively, additional data sources can be used to restrict, adapt and/or optimize the time windows. For example, a comparison is automatically made with a calendar of the user and/or other people living in the household in order to synchronize presence and absence times with the mobile, self-propelled appliance. The presence of the user and/or of other people living in the household can also be detected by the presence of the respective portable additional device in the same network as the mobile, self-propelled appliance. For example, a presence sensor or multiple presence sensors of the respective portable additional device are used, which makes the data available to the mobile, self-propelled appliance. Alternatively or additionally, an optional presence sensor can be used in the mobile, self-propelled appliance. Using these additional data sources, the scheduling of tasks can be adapted even more dynamically and further automated.

The invention is explained in more detail with reference to the following embodiments of the invention, which are merely examples. In the drawings:

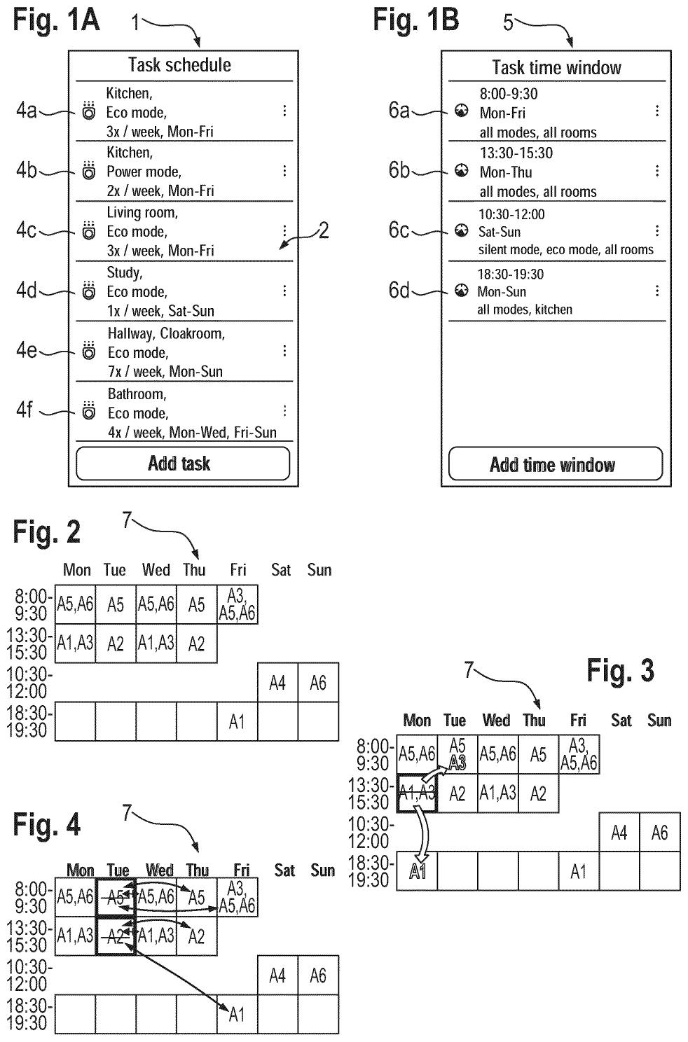

FIGS. 1A, 5A, 6A, 6B: show in each case a schematic display of a task schedule in an app on a portable additional device in relation to a method according to the invention for operating a mobile, self-propelled appliance,

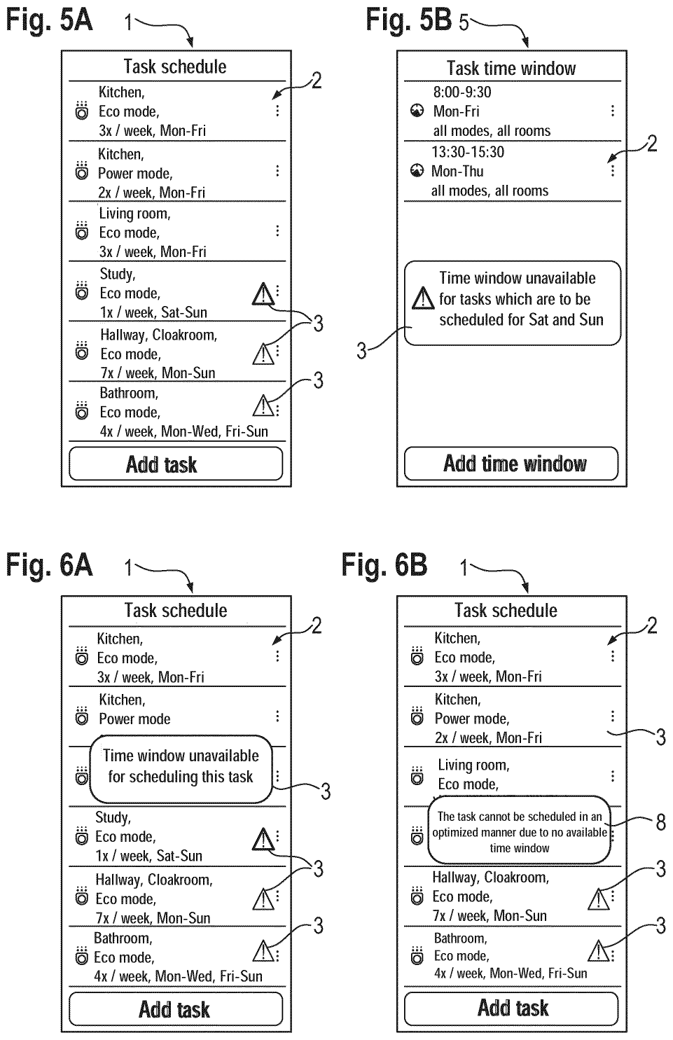

FIGS. 1B, 5B: show in each case a schematic display of a time window in an app on a portable additional device in relation to a method according to the invention for operating a mobile, self-propelled appliance, and

FIGS. 2, 3, 4: show in each case a schematic representation of a task schedule in an app on a portable additional device in relation to a method according to the invention for operating a mobile, self-propelled appliance.

FIG. 1A shows a display 1 of a portable additional device on which a cleaning app 2 is open. Using the portable additional device, which is in particular a cell phone, a user specifies specifications, parameters and/or settings for an operating method of a mobile, self-propelled appliance, in particular a vacuuming robot. In this case, the user does not define on which days and at which time which cleaning program is executed. Instead, the user simply specifies which areas of the home are to be cleaned how often per day, per week or per month, and/or which days of the week are available for this. The user specifies this in the cleaning app, in which the user commands are then displayed, for example, in a list with one line 4a-4f per cleaning task. The user can also specify further cleaning parameters for the respective cleaning task, such as the cleaning mode, for example, in which the respective cleaning task is to be executed.

This results in the following task schedule, for example, which is displayed in the cleaning app:
A1: Kitchen, eco mode, 3×/week, Mon-Fri
A2: Kitchen, power mode, 2×/week, Mon-Fri
A3: Living room, eco mode, 3×/week, Mon-Fri
A4: Study, eco mode, 1×/week, Sat-Sun
A5: Hallway, cloakroom, eco mode, 7×/week, Mon-Sun
A6: Bathroom, eco mode, 4×/week, Mon-Wed, Fri-Sun

In a second input window 5 of the cell phone, the user can specify which time windows are permitted for the respective cleaning, as shown in FIG. 1B, for example. In addition to specifying times of day, such as the start and end of the time window, the user can assign the time windows to specific days of the week and thus map different boundary conditions for different days. It is also possible to restrict for a time window in which rooms and in which cleaning modes and/or with which cleaning parameters the vacuuming robot is to work in these time windows. In this way, the user can define, for example, that the vacuuming robot is only to work in places and/or with settings that do not disturb the user.

The individual time windows are displayed in the cleaning app as a list with one line 6a-6d per cleaning task, for example as follows:
6a: 8:00-9:30, Mon-Fri, all modes, all rooms
6b: 13:30-15:30, Mon-Thu, all modes, all rooms
6c: 10:30-12:00, Sat-Sun, silent mode, eco mode, all rooms
6d: 18:30-19:30, Mon-Sun, all modes, kitchen

The assignment of the defined tasks in lines 4a-4f to the permitted time windows in lines 6a-6d is then carried out automatically, in a self-acting manner or independently by the robot vacuum cleaner. In other words, the robot vacuum cleaner is left to schedule the processing of cleaning jobs. The cleaning app provides the robot vacuum cleaner with time windows in which it can freely schedule when it performs which cleaning task. For example, the user can define the time windows according to their daily routine, for example when the user is at work and is not disturbed by cleaning work at home.

Preferably after each change to the user's input, and particularly preferably at regular intervals, a scheduling and optimization algorithm will schedule the tasks defined by the user into the predetermined time windows. This is illustrated in FIG. 2, for example. FIG. 2 shows a schematic representation of the task allocation 7. The scheduling algorithm optimizes the allocation of the task so that they are allocated as evenly as possible over the days within the given time windows. Tasks in the same rooms, for example A1 and A2 each relate to the kitchen, are not executed on the same days as far as possible.

The cleaning of the same rooms is preferably evenly allocated over a week. If, for example, the cleaning of a room is scheduled three times per week and limited to working days, the jobs are preferably scheduled for Monday, Wednesday and Friday, provided that permitted time windows and other cleaning tasks allow this.

The scheduling algorithm can preferably use stored log data from previous work jobs in order to allow the required duration or battery charge used per room for predetermined cleaning parameters and the times required to recharge the battery to be used in the optimization of the cleaning schedule. This allows the robot vacuum cleaner to divide the cleaning jobs into different time windows of a day in advance in order to take battery recharging into account.

The result of the current scheduling, i.e. the task allocation 7, can be displayed to the user if required, for example in a matrix table with weekdays and time windows, as shown in FIG. 2.

If the vacuuming robot is unable to perform a cleaning task as scheduled, i.e. according to the task allocation 7, the vacuuming robot reschedules, in a self-acting manner, this cleaning task that has not been performed to another time window, which means that this cancelled cleaning task is automatically 4 performed without user intervention (“automated rescheduling”). If, for example, the cleaning task is prevented from being executed on a Monday morning because the user has spontaneously started another cleaning job shortly beforehand or has pressed a “do not clean today” button, the missed cleaning job is scheduled for Monday afternoon or Tuesday, depending on when a time window is available for cleaning. As a result, the user does not have to reschedule the existing cleaning schedule themselves and pay attention to whether an action they are carrying out overlaps with a scheduled cleaning task of the robot vacuum cleaner, but can assume that the robot vacuum cleaner itself will ensure that all the desired cleaning tasks are executed.

FIG. 3 shows a schematic representation of such a task rescheduling. FIG. 3 shows a scheduled task allocation 7 in which rescheduling is necessary. If the execution of tasks, in this case A1 and A3, is not possible, the tasks are scheduled for the next possible time window and a new execution is attempted therein. For example, the cancelled cleaning task A1 is automatically rescheduled from the early afternoon on Monday to the evening on Monday. The cancelled cleaning task A3 is automatically postponed to Tuesday morning due to the limited time window on Monday evening.

In order to avoid duplication or unnecessary repetitions of cleaning tasks, the scheduling algorithm checks during the optimization and rescheduling of cleaning tasks whether cleaning jobs that have similar or identical goals are already scheduled in the corresponding time windows or on the corresponding day. For example, a cancelled cleaning task that the user has scheduled once a day is not necessarily scheduled twice on the same day by rescheduling. In this case, it is possible to actually cancel the cancelled cleaning task. Alternatively, the user can preferably specify in the settings of the cleaning app that a rescheduling should still take place and that the cancelled cleaning task should take place twice on the following day.

A schematic representation of a cancelled cleaning task is shown in FIG. 4. FIG. 4 shows a scheduled task allocation 7, in which a comparison with already scheduled cleaning tasks takes place. If the cleaning tasks A5 and A2 are postponed from Tuesday and have not taken place as scheduled, a check is performed as to whether similar tasks such as A1 and A2, which both affect the kitchen, are scheduled in the next possible time windows. In order to avoid unnecessary duplication of cleaning tasks, i.e. performing similar cleaning tasks several times per day or per time window, these cleaning tasks are not rescheduled but are cancelled completely. A5 is a daily scheduled cleaning task that is cancelled completely after comparison. A2 is a task similar to A1, both of which relate to the kitchen, so it is also scheduled daily and is therefore cancelled completely after comparison.

During the scheduling phase for task allocation, the scheduling and/or optimization algorithm not only checks which cleaning tasks can take place in which time windows, but also whether the intended cleaning tasks can be fitted into the intended time windows at all. If, for example, it is determined that a specific cleaning task has been limited to specific days for which no time window or only an insufficiently long time window has been made available, the user is informed immediately. If no change is made to the task allocation by the user, the cleaning tasks can be omitted depending on the execution or, with additional notification to the user, can be scheduled on days with given time windows, depending on the execution. Information regarding unavailable time windows can be displayed to the user directly in the scheduling windows of the cleaning app.

An example display for incompletely defined tasks is shown in FIGS. 5A, 5B, 6A and 6B. The user is shown notifications 8 or warning notifications 3 if the tasks defined by the user do not match the defined time windows.

The advantage for the user is that in a first step, all cleaning tasks that the user wishes to have executed are created. In a second step, the user can subsequently define suitable time windows for the days or times specified in the notifications and warning notifications in the cleaning app.

The same procedure is possible not only if there are no time windows available when the cleaning tasks are limited to specific days of the week, but also if the time windows are limited to specific performance modes and/or cleaning parameters for specific rooms and/or areas. The procedure can also be improved by incorporating data learned from previous cleaning runs, such as the required duration, required battery charge, required charging times and similar. For example, the user is given feedback on whether the available time windows are sufficient for the intended and scheduled cleaning tasks or whether time windows need to be postponed in order to provide enough time to recharge the battery. Preferably, the time windows are scheduled in such a way that cleaning tasks that have been cancelled and postponed can be compensated for.

The cleaning app preferably displays warning notifications 3 to the user if the tasks defined by the user do not match the specified time windows or if the cleaning tasks are incompletely defined. FIG. 5A, for example, shows symbolic warning notifications 3 for incompletely defined cleaning tasks with an exclamation mark arranged in a warning triangle. FIG. 5B shows, for example, a warning notification 3 in the case of unavailable time windows, in which an informative written warning notification 3 is shown next to a symbolic warning notification. The written warning notification 3 informs the user that it is not possible to schedule all the cleaning tasks using the unavailable time windows.

Preferably, the scheduling algorithm offers the user suggestions on how the time windows can be adapted in order to facilitate optimal the scheduling of the cleaning tasks. The cleaning app 2 therefore displays information notification 8 if the given time windows do not allow an optimal solution, but the cleaning tasks can still be scheduled and executed with the given boundary conditions.

FIG. 6A shows a list of the intended cleaning tasks on the display 1 of a cell phone that is shown in a cleaning app 2 in which cleaning tasks cannot be scheduled due to a lack of time windows. Here, the user receives a direct warning notification 3. For cleaning tasks that cannot be optimally allocated due to insufficient time windows, the user receives information notifications 8 in the cleaning app 2 on the display 1, as shown in FIG. 6B.

Preferably, the user can use a “not today” button in the cleaning app, for example, to indicate that they do not want any cleaning tasks to be performed on the current day or in the next few hours (not shown). Pressing this button prevents the execution of scheduled cleaning tasks. In this case, the vacuuming robot automatically and in a self-acting manner postpones the cancelled cleaning tasks and reschedules them so that all intended cleaning tasks are executed automatically and reliably without user intervention.

1-10. (canceled)

11. A method for operating a mobile, self-propelled appliance, which comprises the steps of:
specifying, via a user, on a portable device at least one cleaning task to be executed in at least one predetermined time window, specifying a number of executions to be performed in the at least one predetermined time window and specifying further cleaning parameters and/or boundary conditions; and
generating in a self-acting manner, via the mobile, self-propelled appliance a task allocation when which cleaning tasks are to be performed in the at least one predetermined time window using specified cleaning parameters and/or boundary conditions.

12. The method according to claim 11, which further comprises automatically performing the task allocation by the mobile, self-propelling appliance.

13. The method according to claim 11, wherein a cleaning task that was scheduled by the user but partially executed or prevented is rescheduled by the mobile, self-propelling appliance itself.

14. The method according to claim 11, wherein the further cleaning parameters and/or boundary conditions are selected from the group consisting of: a cleaning mode, a cleaning performance, a maximum volume, and a quantity of water.

15. The method according to claim 11, which further comprises specifying a common time window and/or at least partially different time windows for the cleaning tasks to be executed.

16. The method according to claim 11, wherein the at least one predetermined time window includes specific days of a week and/or times of day.

17. The method according to claim 11, which further comprises creating the task allocation by means of a scheduling algorithm and/or an optimization algorithm.

18. The method according to claim 17, wherein the scheduling algorithm and/or optimization algorithm uses stored log data from previous cleaning jobs.

19. The method according to claim 17, wherein the scheduling algorithm and/or optimization algorithm allocates cleaning jobs that have similar or identical goals as evenly as possible over the at least one predetermined time window.

20. The method according to claim 11, which further comprises showing the user unavailable time windows as warning notifications and/or information notifications regarding an improved task allocation on the portable device.

21. The method according to claim 11, wherein the mobile, self-propelled appliance is a floor-cleaning appliance or a vacuuming robot and/or a sweeping robot and/or a mopping robot.
